(19) United States
(12) Patent Application Publication
(10) Pub. No.: US 2026/0138303 A1
(43) Pub. Date: May 21, 2026

(54) PRINT HEAD OF A 3D CONSTRUCTION PRINTER

(71) Applicant: AC3D, INC., San Francisco, CA (US)

(72) Inventors: Boris Kozlov, Moscow (RU); Dmitrii Konshin, Balashikha (RU)

(21) Appl. No.: 19/118,522

(22) PCT Filed: Sep. 7, 2023
(86) PCT No.: PCT/RU2023/050212

§ 371 Date: Apr. 4, 2025

(30) Foreign Application Priority Data
Oct. 6, 2022 (RU) 2022126131

(51) Int. Cl. B28B 1/00; B33Y 30/00

(52) U.S. Cl. CPC B28B 1/001; B33Y 30/00

(57) ABSTRACT

The invention relates to a print head of a 3D construction printer, which acts as a mixer-extruder, and can be used for constructing buildings and fabricating parts of building structures using concrete or other building mixes. The print head contains a housing having three storage hoppers installed therein, each having installed therein a shaft for mixing and delivering a concrete mix. The delivery part of each shaft is configured in the form of a rotor of a gerotor assembly, and each shaft has its own actuator respectively. The storage hoppers are movable in one plane relative to one another, and installed on each stator of each gerotor assembly of each hopper are replaceable nozzles, respectively. The result is an increase in the speed of printing the walls of a building and an improvement in the thermal performance and strength of printed walls.

### TECHNICAL FIELD

The invention relates to the field of construction, specifically to a print head for a construction 3D printer that functions as a mixer-extruder, as well as to construction three-dimensional printing of articles using additive technology from multi-component mixtures for the purpose of manufacturing building structures. It can be used, in particular, for the construction of residential houses, buildings and structures for various purposes, the fabrication of parts and elements of buildings, and components of building structures made of concrete or other construction mixes.

### DETAILED DESCRIPTION

From the state of the art, a 3D printer print head is known (see [1] Utility Model Patent of the Russian Federation No. 179153, IPC E04G 21/16, B41J 2/335, publ. 28 Apr. 2018), consisting of a nozzle and a mixer-extruder connected to it, which includes a housing, a screw with cylindrical and conical sections, valves for supplying individual components of the mixture, and a screw drive.

From the state of the art, a construction 3D printer extruder is known (see [2] Utility Model Patent of the Russian Federation No. 185166, IPC E04G 21/04, B41J 2/335, B29C 47/10, publ. 23 Nov. 2018), comprising a print head connected via a mixture feed mechanism drive to a mixture feed mechanism drive motor and a screw. A surface forming device is installed on the print head, a mounting mechanism is installed on the mixture feed mechanism drive connecting a stationary mixture supply tube connected to it and a hermetic connection to which a mixture supply tube located inside the feed mechanism drive and rotating with it and the screw is connected, with mixture supply nozzles installed on this tube.

Also known from the state of the art is a construction mix extruder for a 3D printer (see [2] Invention Patent of the Russian Federation No. 2724163, IPC B29C 64/209, publ. 22 Jun. 2020), consisting of a container with a mounting device allowing the extruder to be fixed to the printer's actuators, an opening for loading construction material, and a nozzle with an outlet for extruding the construction material. The lower part of the container integrates a construction mix dispenser that allows regulating the amount of construction mix during the formation of the printed layer. The extruder includes a mixing device made in the form of a mixing frame with a drive that simultaneously serves as the drive for the construction mix dispenser. The construction mix dispenser can be implemented as a screw or a gerotor pair.

The closest prior art, taken as a prototype, is a mixer from ConcreteFlow, which has two extruders in its design. A disadvantage of the prototype is that two extruders speed up the printing process for identical objects but do not solve the problem of printing a multi-layered wall. The extruders in the head do not have the ability to shift and, accordingly, it is impossible to print a stable structure of at least two layers of sufficient height using this mixer. Such a mixer is only suitable for printing small objects in workshop conditions and is not suitable for printing the walls of an entire building on a construction site. Furthermore, the problem of printing a middle heat-insulating layer is not addressed.

A disadvantage of all known analogues is that the print head is capable of extruding only one type of mixture and only in one layer per pass. To form an object consisting of several different layers placed on the same plane and adjacent to each other by their side surfaces, it is necessary to make a new pass of the head for each layer. Thus, the process of creating, for example, a multi-layered wall is significantly slowed down due to the need to return the head to the same contour to print a new parallel layer.

### SUMMARY OF THE INVENTION

The object of the claimed invention is to eliminate the disadvantages of the analogues and the prototype, as well as to create the possibility of printing building walls consisting of three layers, each of which can have characteristics different from the others, in a single pass.

The technical result of the claimed invention is to increase the printing speed of building walls, improve thermal performance, and improve the strength characteristics of the printed walls.

The stated technical result is achieved by the fact that the print head includes a housing in which three hoppers are installed, each of which has a mixing and concrete mix feeding shaft. The feeding part of each shaft is designed as a rotor of a gerotor pair, and each shaft has its own drive. The hoppers are designed with the ability to move relative to each other in one plane, and replaceable nozzles are installed on each stator of each gerotor pair of each hopper.

Each shaft is made in the form of two separate shafts—a mixing shaft and a concrete mix feeding shaft—each with its own drive.

The middle hopper with its shaft is designed to be movable due to its own drive. The replaceable nozzles are designed to be rotatable due to their own drive.

The replaceable nozzles have shaping elements for the layer formation during extrusion.

### BRIEF DESCRIPTION OF THE DRAWINGS

FIG. 1 is a schematic representation of the print head.

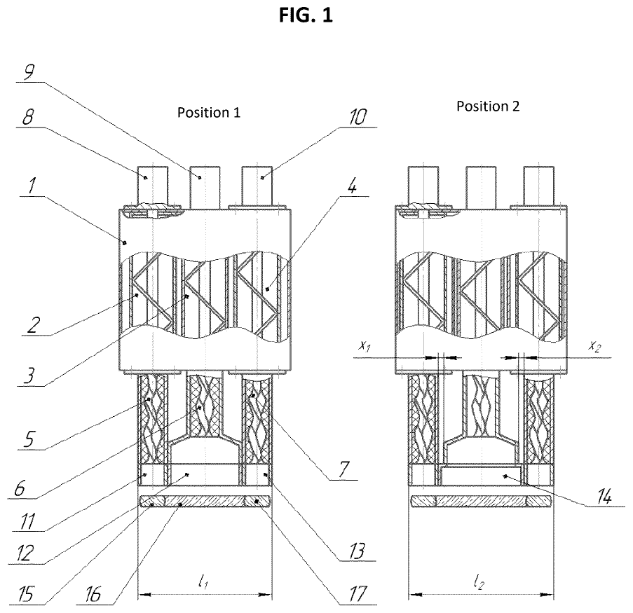

The following positions are indicated in the figure: 1—housing; 2, 3, 4—hoppers; 5, 6, 7 mixing and feeding shafts; 8, 9, 10—shaft drives; 11, 12, 13, 14—replaceable nozzles; 15, 16, 17 —formed layers.

### DETAILED DESCRIPTION OF THE INVENTION

The print head includes a housing (1) in which three hoppers (2), (3), (4) are installed, each of which has a mixing and concrete mix feeding shaft (5), (6), (7). The feeding part of each shaft is designed as a rotor of a gerotor pair, and each shaft (5), (6), (7) has its own drive (8), (9), (10), respectively. The hoppers (2), (3), (4) are designed with the ability to move relative to each other in one plane, and replaceable nozzles (11), (12), (13), (14) are installed on each stator of each gerotor pair of each hopper (2), (3), (4), respectively.

Each shaft (5), (6), (7) is made in the form of two separate shafts—a mixing shaft and a feeding shaft—each with its own drive.

The middle hopper (3) with its shaft (6) is designed to be movable due to its own drive. The replaceable nozzles are designed to be rotatable due to their own drive.

The replaceable nozzles have shaping elements for layer formation during extrusion.

The hoppers (2), (3), and (4) are installed in such a way that relative to the initial width |1 of the printed triple layer in position 1, the width in position 2 of the new layer l2=l1+x1+x2, where x1 and x2 are the distances by which hoppers (2) and (4) have been moved, respectively. A new nozzle (14) is installed on the stator of the rotor of the shaft of hopper (3). A mixture of high-strength concrete is fed into hoppers (2) and (4), the purpose of which is to form strong inner and outer layers of the future printed wall. Foam concrete is fed into hopper (3), the purpose of which is to create an insulating layer inside the wall. The shafts (5), (6), (7) are rotated at the required frequency by drives (8), (9), (10), respectively. The mixing part of the shafts mixes the concrete mixture, and the feeding part pushes the mixture through the corresponding nozzles (11), (12), (13), (14). At the outlet, three adjacent layers are formed, creating a cross-section of the printed three-layer wall.

A typical building wall printed on a 3D printer usually has three layers: outer and inner layers made of strong concrete suitable for printing, and an inner layer made of, for example, foam concrete or any other filler, the purpose of which is to provide the necessary thermal performance of the wall. In this case, the advantage of foam concrete compared to other fillers is that, as a result of adhesion with the outer layers of the wall, it creates a unified structure that better withstands loads from the building's floors. However, the cavity between the outer layers of strong concrete is filled with foam concrete only after these layers have been printed to a height that guarantees that the poured column of foam concrete will not create such pressure on the outer walls that it will destroy or deform them. This creates the need for technological breaks in the wall printing process so that all layers set and gain sufficient strength, which slows down the construction process. In addition, printing only the outer, usually quite thin layers, to a certain height also requires printing connecting elements between these layers to create a stable structure. However, these connecting elements subsequently become thermal bridges and worsen the thermal performance of the wall. Therefore, it is most expedient to print all three layers of the wall in one pass. This ensures good adhesion between them, saves time on head passes, and also eliminates the problem of the need to stop printing to pour foam concrete or any other concrete into the cavity between the outer layers, as all three layers simultaneously gain strength and there is no excessive pressure on the thin outer walls from the liquid filler.

The claimed device solves this problem because, by changing the position of the shafts using their own drives and replacing the corresponding nozzles, it is possible to print a three-layer wall of various thicknesses and consisting of concrete layers with different characteristics in one pass, which makes it possible to increase the printing speed of building walls, improve thermal performance, and improve the strength characteristics of the printed walls.

The rotation of the replaceable nozzles of the print heads allows configuring the surface of the layers.

The presence of a separate drive for the middle hopper with its shaft allows printing the middle layer in the form of connecting elements between the outer layers, therefore reducing the number of passes of the print head when printing a wall.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A printing head comprising a housing in which three storage hoppers are installed, each of the three storage hoppers having a shaft for mixing and feeding a concrete mixture installed therein, wherein a feeding part of each shaft is designed as a rotor of a gerotor pair, wherein each shaft has its own drive, respectively, wherein the storage hoppers are configured to be movable in one plane relative to each other, and wherein replaceable nozzles are installed on each stator of each gerotor pair of each of the three storage hoppers, respectively.

2. The system according to claim 1, wherein each shaft is made in a form of two separate shafts—a mixing shaft and a feeding shaft—each with its own drive.

3. The system according to claim 1, wherein a middle hopper of each shaft is configured to be movable by means of its own drive.

4. The system according to claim 1, wherein the replaceable nozzles are configured to rotate by means of their own drive.

5. The system according to claim 1, wherein the replaceable nozzles are provided with shaping elements for forming a layer during extrusion.
